(19) United States
(12) Patent Application Publication
(10) Pub. No.: US 2008/0190009 A1
(43) Pub. Date: Aug. 14, 2008

(54) Fish Roe Cluster Lure

(76) Inventor: Michael T. Shelton, North Charleston, SC (US)

Correspondence Address: HAMMER & ASSOCIATES, P.C., 3125 SPRINGBANK LANE, SUITE G, CHARLOTTE, NC, 28226, US

(21) Appl. No.: 12/063,201

(22) PCT Filed: Sep. 8, 2006
(86) PCT No.: PCT/US06/34837

§ 371 Date: Feb. 7, 2008

Related U.S. Application Data
(60) Provisional application No. 60/716,015, filed on Sep. 9, 2005.

(51) Int. Cl. A01K 85/00

(52) U.S. Cl. 43/42.06; 43/42

(57) ABSTRACT

A fishing lure component or fishing lure which comprises a plurality of egg shaped members connected by a line, where the plurality of egg shaped members and the line are made of an elastomeric material, the elastomeric material having a shore OO durometer of less than or equal to 15.

### BACKGROUND OF THE INVENTION

The present invention provides a fishing lure or a fishing lure component which simulate a cluster of eggs.

The use of artificial baits, such as fish eggs and fish egg clusters are an excellent alternative to natural roe, one can eliminate all the trouble of finding, curing, storing and using natural salmon eggs or other natural eggs, not to mention the mess.

U.S. Pat. No. 3,579,895 teaches the production of artificial fish eggs made of a PVC resin which have a shore A durometer of 3-10. Shore A durometer is test for a harder plastic like PVC, the eggs in the preferred range would have a shore OO durometer of about 45 or more and would feel much harder than real fish eggs.

It is a proven fact that single eggs, small egg clusters and the larger gooey bobs account for as many Steelhead caught as cured salmon eggs. There are many advantages to using artificial baits, such as fish eggs and fish egg clusters they come in endless sizes, shapes, and colors. From red to several shades of orange, pink, peach, and chartreuse, these eggs are also available in florescent and translucent colors. Sizes can vary from small caviar eggs to the size of a quarter. There are two key factors to remember when using artificial baits, fish them with the same presentation as you would roe and the artificial eggs have no taste and the texture is harder, so the fish will spit out the lure quickly.

The later has been a big problem with artificial fish eggs, the fish can't seem to spit out artificial eggs made of plastic, cork or metal fast enough. Therefore there is a real need to an artificial fish egg which simulates the texture and hardness of real fish eggs.

### SUMMARY OF THE INVENTION

A fishing lure component which comprises a plurality of egg shaped members connected by a line, where the plurality of egg shaped members and the line are made of an elastomeric material, the elastomeric material having a shore OO durometer of less than 15.

### BRIEF DESCRIPTION OF THE DRAWINGS

The foregoing will become more readily apparent by referring to the following detailed description and the appended drawings in which:

FIG. 1 is a perspective view of the synthetic fish roe cluster used as a lure; and

FIG. 2 is a perspective view of the synthetic fish roe strand;

FIG. 3 is another view of the synthetic fish roe strand;

FIG. 4 is another view of the synthetic fish roe strand which shows its elasticity;

FIG. 5 is another view of the synthetic fish roe strand which is being tied into a cluster;

FIG. 6 is another view of the synthetic fish roe cluster;

FIG. 7 is a chart with a comparison of shore A to shore OO durometer readings.

### DETAILED DESCRIPTION OF THE INVENTION

A fishing lure or a fishing lure component 10, FIG. 2, which comprises a plurality of egg shaped members 20 connected by a line 30, where the plurality of egg shaped members are made of an elastomeric material, the elastomeric material having a shore OO durometer of less than 15. The line is made from material selected from the group of: elastomeric materials, cotton, jute, hemp, wool, silk, porous plastics or combinations thereof. In one of the embodiments of the invention the line 30 is made of the same elastomeric material as the plurality of egg shaped members 20. This allows the lure component 10 to be injection molded using a single uniform material.

The fishing lure component of the present invention may further comprise a colorant. The egg shaped members 20 and line 30 may incorporate a color additive, or colorant, which is selected from the group consisting of: pigment, dye, color, glitter, foil, MYLAR (a polyethylene terepthalate film), holograms, mica, or combinations thereof. It is also possible for the colorant to be applied to the surface of the strands by a spray, printing or direct application method such as by brush or roller.

The fishing lure component of the present invention where the size and shape of the egg shaped members 20 are similar to real fish eggs. The size shape and color of the egg shaped members may also be similar to insect or amphibian eggs.

The fishing lure component of the present invention where the elastomeric material is a gelatinous elastomeric composition of a mixture of a thermoplastic elastomer (TPE) and an oil (or plasticizer). It has been found that the use of TPE having a specific gravity of less than 0.95 perform better than something having a specific gravity of greater than 1.0. This bait component works well when the specific gravity is in the range of 0.76 to 0.88. Having a specific gravity which is less than water allows this bait component to float which helps in its simulation of real fish roe. In one embodiment of this invention, the composition is a mixture of a styrenic block copolymer and an oil, where the oil is in excess, by weight, of the copolymer. In one embodiment the composition is a mixture of one or more styrenic block copolymers and at least two oils, where the oil is in excess, by weight, of the copolymer and one oil is used in excess of the other oil, by weight. This is taught in my co-pending application Ser. No. 10/460,064.

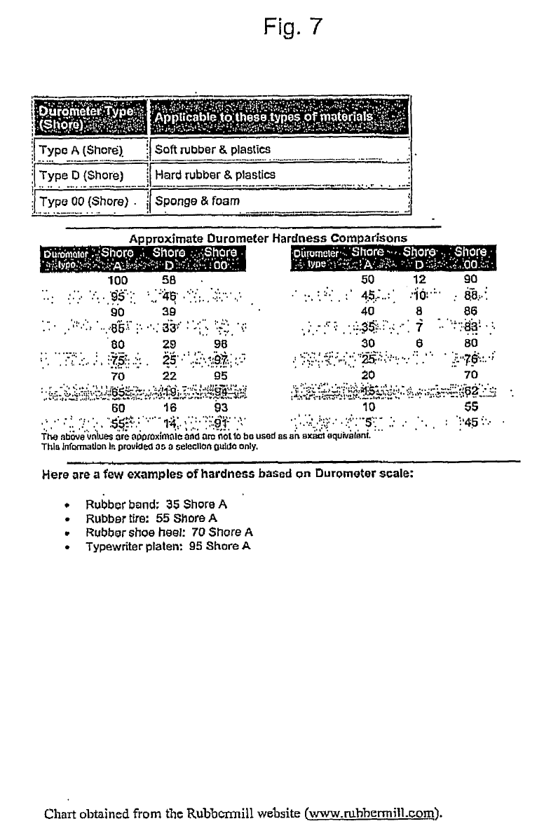

These gelatinous elastomeric compositions are elastic, tear resistant, and soft. They are elastic and can be stretched several times their original length see FIG. 4. They are tear resistant and can withstand being stretched. They are soft and have a Shore OO hardness less than or equal to 15. The Shore hardness is measured with an apparatus known as a Durometer and consequently is also known as ‘Durometer hardness’. The hardness value is determined by the penetration of the Durometer indenter foot into the sample. Because of the resilience of rubbers and plastics, the indentation reading my change over time—so the indentation time is sometimes reported along with the hardness number. The ASTM test method designation is ASTM D2240 OO and is generally used in North America. The Shore OO is used to measure very soft compounds, harder compounds can be measured with a Shore A, or a Shore D, Durometer, see FIG. 7. Related methods include ISO 7619 and ISO 868; DIN 53505; and JIS K 6301, which was discontinued and superseded by JIS K 6253. The results obtained from this test are a useful measure of relative resistance to indentation of various grades of polymers.

The styrenic block copolymers are thermoplastic elastomers. Their structure normally consists of a block of a rigid styrene on each end with a rubbery phase in the center. Styrenic block copolymers include, but are not limited to, SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene). These materials are commercially available from, for example, SEPTON Company of America, Pasadena, Tex. and Kraton Polymers, Houston, Tex. Exemplary SEPTON (US) products include SEPTON 4055 (SEEPS); SEPTON 8006 (SEBS); and SEPTON 2006 (SEPS). Exemplary Kraton (US) products include KRATON 1651 (SEBS). It is possible to use just one of these polymers or a combination of these polymers. It will be know to those of skill in the art by varying the amount of copolymer and oil one can achieve an end product having different durometer readings.

The oil or plasticizer generally refers to mineral oils or silicone (dimethyl silaxone) oil. The oil is mixed with the styrenic block copolymer. The heavier oils (i.e., greater molecular weights or greater viscosity) decreased heat deformation and processibility, and increased surface tack. Such oils are commercially available from, for example, Crompton Corporation (Witco Refined Products), Greenwich, Conn. Exemplary oils include: BLANDOL white mineral oil, specific gravity @25° C./25° C. (ASTM D4052)—0.839/0.855; Kinematic viscosity @40° C., CST (ASTM D445)—14.2/17.0 (heavy oil), and SEMTOL white mineral oil, specific gravity @25° C./25° C. (ASTM D4052)—0.804/0.827, Kinematic viscosity @40° C., CST (ASTM D445)—3.9/5.5 (light oil). It may also be possible to use natural oils such as corn oil, olive oil, fish oil or cod liver oil.

Other conventional additives may also be added. Such additives include: UV-stabilizer, heat-stabilizer, pigments, dyes, flavorant, attractants, and the like. The attractants can be added to either the egg shaped members or line or both, one of the goals is for this bait component to look, feel, smell and taste like natural fish roe or insect or amphibian eggs. Examples of fish attractants include but are not limited to fish oil, cod liver oil, fish meal, salt, garlic or anise (licorice) scents, commercially available fish attractants, oils which may include extracted from shad, menhaden, shrimp, eel, crayfish, baitfish, worms and/or other water-oriented creatures. Active ingredients in some attractants may also partially or completely include extracts of garlic, anise, other plants, fruits, or seeds. Some are also laced with odorless, tasteless compounds of enzymes, hormones and pheromones that the manufacturer suggests may trigger a feeding response or other type of biological response in bass or other types of fish. Often, the materials used to manufacture fish attractants are the by-products or left-overs of some other product manufacturing process, like making fish meal or cat food for instance. These by-products are often pressed or otherwise further processed to extract the oils and compounds to be used in the fish attractants. The extracted oils contain natural protein and amino acid particles. These active ingredients are often mixed with a heavier, thicker inert base oil or gel that provides for better, longer-lasting underwater adhesion to plastic.

The fishing lure component of the present invention, in one embodiment, where the elastomeric material is a styrenic blocked copolymer material having a shore OO durometer of 3 to 15, in another embodiment the shore OO durometer is 4 to 12. In another embodiment the elastomeric material is a styrenic blocked copolymer material having a shore OO durometer of less than or equal to 20 and in another embodiment a shore OO durometer of less than or equal to 18.

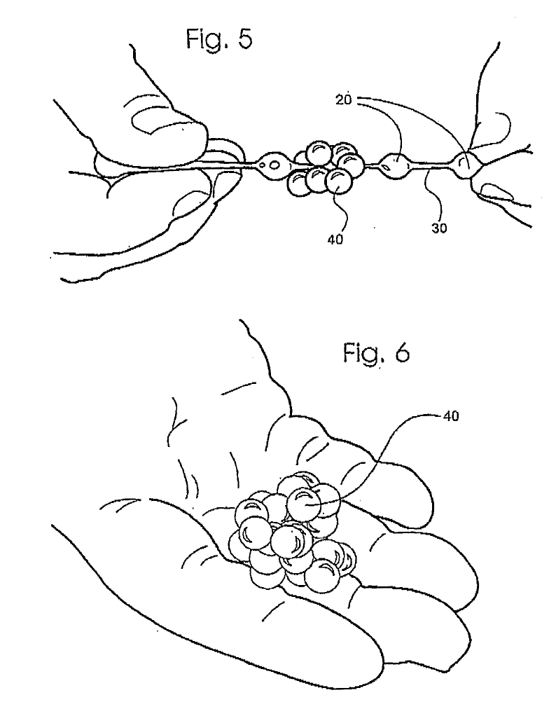

In another embodiment of the present invention teaches a fishing lure component comprising a plurality of egg shaped members 20 connected by a line 30, where the plurality of egg shaped members are made of a styrenic blocked copolymer material, the styrenic blocked copolymer material has a shore durometer of less than or equal to 15 and where said line is made from material selected from the group of: elastomeric material, styrenic blocked copolymer, cotton, jute, hemp, wool, silk, rubber, porous plastics, plastics or combinations thereof. It will be readily apparent to one skilled in the art that if the line 30 is made from an elastic material, in one embodiment, such as a styrenic blocked copolymer or rubber or a spandex line, that the line will be elastic as shown in FIGS. 4 and 5. Further if the line 30, in another embodiment is made from a hard plastic, or cotton or other natural material it will be far less elastic or in another embodiment it might not stretch at all.

The fishing lure component of the present invention where the size of the egg shaped members are similar to natural fish eggs. It will be possible to attract different types of fish by using eggs that simulate the eggs they particularly like or by simulating the natural eggs of insects or amphibians. This simulation can be enhanced by changing the size and shape of the egg shaped members, or by adding in color or attractants which simulate these natural eggs the best. Further, it is possible that other attractants which may not faithfully mimic the eggs of fish, amphibians or insects but that are effective in attracting fish may also work well, examples of which can include using glitter, foil, cod liver oil, garlic or anise (licorice) scents.

In another embodiment the spheres or egg shaped members can injected around a built in leader or other lure connection. The line may be the same material as the egg shaped members or it can be a different material selected from the group of: elastomeric material, styrenic blocked copolymer, cotton, jute, hemp, wool, silk, rubber, porous plastics, plastic or combinations thereof. It will be clear that plastic includes matters such as nylon, polypropylene, polyethylene, polyethylene terephthalate, SPANDEX (which is defined as a manufactured fiber in which the fiber-forming substance is a long chain synthetic polymer of at least 85% of a segmented polyurethane) and other polymers which can be made in line or are useful in blending with other plastic or natural fibers to be made in line or yarns. In manufacture of this product the product may be manufactured by molding these strands of connected spheres to the desired lengths or they can be made in a long length and then subsequently cut to any desired length.

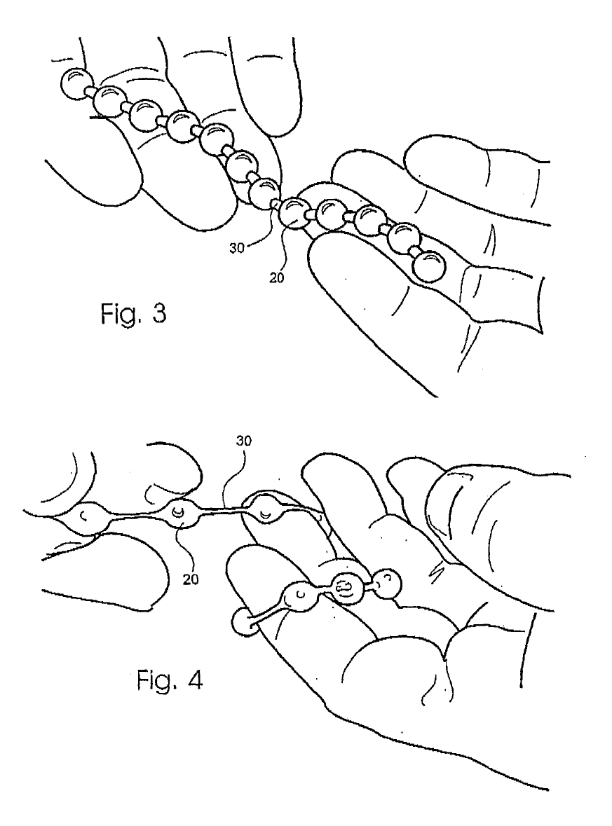

In another embodiment of the present invention teaches a method of simulating natural roe used as a lure, comprising the steps of: providing a string of a plurality of egg shaped members connected by a line FIG. 3, where the plurality of egg shaped members are made of an elastomeric material and the lines are made from material selected from the group of: elastomeric material, styrenic blocked copolymer, cotton, jute, hemp, wool, silk, rubber, porous plastics, plastics or combinations. In one embodiment the line is made of an elastomeric material in one of the embodiments the line is made from the same styrenic blocked copolymer used in the egg shaped components where the elastomeric material has a shore durometer of less than 15 as can be seen in FIG. 4. The string is then tied together, FIG. 5, so that the string simulate a cluster 40, FIG. 6, of fish eggs or amphibian eggs or insect eggs.

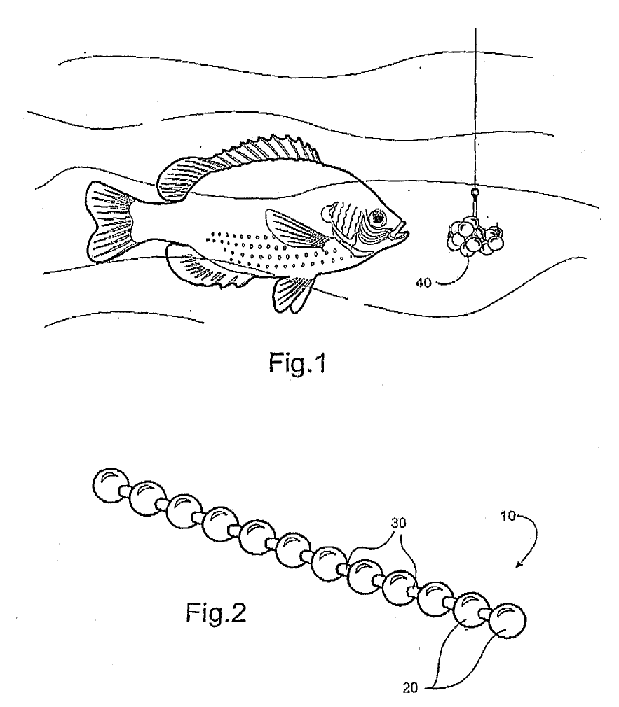

It should be clear that in the specification or claims the term lure used here is defined as a bait, especially an artificial one, used in fishing. Therefore the lure or lure component 10 is really the same thing. One of ordinary skill in fishing will recognize that the lure or lure component 10 can be used as a lure as shown in FIG. 1, or it can be combined with other lure components such as, but not limited to, spinners, spoons, feathers, hooks, sinkers, weighted hooks etc. to create an overall lure.

In another embodiment the invention is a fishing lure or a fishing lure component comprising an egg shaped or multiple egg shaped members, where said egg shaped member is made of an elastomeric material, the elastomeric material having a shore OO durometer of less than or equal to 15. It should be noted that a single egg shaped member could be used or that the egg shaped members could be molded individually and then subsequently glued together to form a cluster or a cluster could be molded from the elastomeric material having a shore OO durometer of less than or equal to 15.

### EXAMPLES

The following are some examples of formulations of styrenic block copolymers which are capable of producing a Shore OO value in the desired range.

| Component | A | B | C | D | E | F |
|---|---|---|---|---|---|---|
| oil | 88% | 84% | 83% | 82% | 82% | 81% |
| SEEPS | 4% | 7% | 7% | 7% | 0% | 0% |
| SEPS | 0% | 3% | 3% | 3% | 0% | 0% |
| SEBS | 8% | 4% | 4% | 6% | 17% | 19% |
| Other | 0% | 2% | 2% | 2% | <.1% | 0% |
| Additives | | | | | | |
| Total | 100% | 100% | 100% | 100% | 100% | 100% |
| Durometer | 6.6 | 10 | 12 | 15 | 14.8 | 18.2 |

In examples B-D SEBS was Septon 2006, in Example E SEBS was Kraton 1651, in example A SEBS was blend of SEPTON 2006 and Kraton 1651. SEEPS was Septon 4055 and SEPS was Septon 2006.

What is claimed is:

1. A fishing lure component or a fishing lure comprising:
a plurality of egg shaped members connected by a line, where said plurality of egg shaped members are made of an elastomeric material, said elastomeric material having a shore OO durometer of less than or equal to 15.

2. The fishing lure component according to claim 1 further comprising an additive selected from the group of: colorants, flavorants, attractants or combinations thereof.

3. The fishing lure component according to claim 1 where the size and shape of the egg shaped members simulate real eggs from fish, insects or amphibians.

4. The fishing lure component according to claim 1 where the elastomeric material is a styrenic blocked copolymer material.

5. The fishing lure component according to claim 4 where the elastomeric material is a styrenic blocked copolymer material having a shore durometer of 12 to 4.

6. The fishing lure component according to claim 1 where said line is made from material selected from the group of: elastomeric materials, cotton, jute, hemp, wool, silk, porous plastics, plastic or combinations thereof.

7. The fishing lure component according to claim 1 where said elastomeric material floats in water.

8. The fishing lure component according to claim 1 where said elastomeric material has a specific gravity of 0.95 or less.

9. The fishing lure component according to claim 7 where said elastomeric material has a specific gravity in the range of less than or equal to 0.88 and more than or equal to 0.76.

10. A fishing lure component comprising:
a plurality of egg shaped members connected by a line, where said plurality of egg shaped members are made of a styrenic blocked copolymer material, said styrenic blocked copolymer material has a shore durometer of less than or equal to 15 and where said line is made from material selected from the group of: elastomeric material, styrenic blocked copolymer, cotton, jute, hemp, wool, silk, porous plastics, plastic or combinations thereof.

11. The fishing lure component according to claim 9 further comprising an additive from the group of: colorants, flavorants, attractants or combinations thereof.

12. The fishing lure component according to claim 9 where the size and shape of the egg shaped members simulate real eggs from fish, insects or amphibians.

13. The fishing lure component according to claim 9 where the styrenic blocked copolymer material is selected from the group of: SBS (styrene butadiene styrene), SIS (styrene-isoprene-styrene), SEPS (styrene ethylene/propylene styrene), SEBS (styrene ethylene/butylene styrene), and SEEPS (styrene ethylene/ethylene-propylene-styrene) and combinations of these polymers.

14. The fishing lure component according to claim 12 where the elastomeric material is a styrenic blocked copolymer material having a shore durometer of 4 to 12.

15. The fishing lure component according to claim 9 where said styrenic blocked copolymer material has a specific gravity of 0.95 or less.

16. A fishing lure component or a fishing lure comprising a single egg shaped member or a plurality of egg shaped members, where said single egg shaped member or said plurality of egg shaped members are made of an elastomeric material, said elastomeric material having a shore OO durometer of less than or equal to 15.

17. The fishing lure component according to claim 16 further comprising an additive selected from the group of: colorants, flavorants, attractants or combinations thereof.

18. A fishing lure component or a fishing lure comprising a mold that simulate a cluster of egg shaped members, where said mold is made of an elastomeric material, said elastomeric material having a shore OO durometer of less than or equal to 15.

19. A method of simulating roe used as a lure, comprising the steps of:
providing a string of a plurality of egg shaped members connected by a line, where said plurality of egg shaped members are made of an elastomeric material and said line is made from material selected from the group of: elastomeric material, styrenic blocked copolymer, cotton, jute, hemp, wool, silk, porous plastics, plastic or combinations thereof, said elastomeric material of said egg shaped members having a shore OO durometer of less than or equal to 15;
tying said string together to simulate a cluster of eggs.

20. The method of simulating roe used as a lure according to claim 16 where said line is made of the same material as said egg shaped member.
